(19) United States
(12) Patent Application Publication
(10) Pub. No.: US 2013/0055000 A1
(43) Pub. Date: Feb. 28, 2013

(54) COMPUTING APPARATUS AND HIBERNATION METHOD THEREOF

(71) Applicants: Changman LEE, Seoul (KR); Min Chan KIM, Suwon-si (KR); JooYoung HWANG, Suwon-si (KR)

(72) Inventors: Changman LEE, Seoul (KR); Min Chan KIM, Suwon-si (KR); JooYoung HWANG, Suwon-si (KR)

(73) Assignee: SAMSUNG ELECTRONICS CO., LTD., Suwon-si, (KR)

(21) Appl. No.: 13/587,347

(22) Filed: Aug. 16, 2012

(30) Foreign Application Priority Data
Aug. 22, 2011 (KR) 10-2011-0083534

(51) Int. Cl. G06F 1/00; G06F 9/46

(52) U.S. Cl. 713/323

(57) ABSTRACT

A hibernation method of a computing apparatus is provided to rapidly cancel a hibernation operation and rapidly restore a previous working state. The hibernation method includes classifying some processes or some pages of working processes into a priority working process according to priority for restoring a working state of the computing apparatus, detecting a user input to cancel a hibernation operation, cancelling the hibernation operation and activating the priority working group in response to the user input, and activating processes or pages that are not classified into the priority working group after activating the priority working group. According to the hibernation method, hibernation that is in progress may be rapidly cancelled in response to a user input. The previous working state may be promptly restored from a hibernation state.

### CROSS-REFERENCE TO RELATED APPLICATIONS

This US non-provisional patent application claims priority under 35 USC §119 to Korean Patent Application No. 10-2011-0083534, filed on Aug. 22, 2011, in the Korean Intellectual Property Office (KIPO), the entire contents of which is hereby incorporated by reference.

### BACKGROUND

Example embodiments of the inventive concepts described herein generally relate to computing apparatuses and hibernation methods thereof and, more particularly, to a computing apparatus and a hibernation method thereof.

With the recent trend toward environment-friendly and low-power technologies, there have been proposed methods for reducing power consumption of a computing apparatus. Especially in a mobile device, low power consumption becomes a significant function associated with the capacity of a battery and operating time of the device.

Hibernation has been used as one of the methods for low power consumption. Hibernation is a method for reducing power consumed in a standby state by shutting off the power supplied to each device of a computing apparatus in the standby state. At this point, the computing apparatus stores a previous working state as an image. When the standby state is terminated, the computing apparatus may read and activate the stored hibernation image to restore the previous image state.

Because hibernation has been employed in a number of computing apparatuses, the major task in electronic technical fields is to enhance performance of the hibernation.

### SUMMARY

Example embodiments of the inventive concepts provide a computing apparatus and a hibernation method thereof.

According to at least one example embodiment of the inventive concepts, the hibernation method may include classifying some processes or some pages of working processes into a priority working process according to priority for restoring a working state of the computing apparatus; detecting a user input to cancel a hibernation operation; cancelling the hibernation operation and activating the priority working group in response to the user input; and activating at least one of processes and pages that are not classified into the priority working group after activating the priority working group.

In an example embodiment, the priority working group may include visualization processes among the working processes.

In an example embodiment, the visualization processes may include a rendering process or processes having a graphic user interface.

In an example embodiment, the priority working group may include background pages required to drive the computing apparatus and the visualization processes.

In an example embodiment, the background pages may include pages activated within a pre-set time, among the working processes, when the working processes are executed after a main memory of the computing apparatus is initialized.

In an example embodiment, the priority working group may include processes given by a manufacturer or a user of the computing apparatus.

In an example embodiment, the hibernation method may further include generating a hibernation image including the priority working group.

In an example embodiment, the hibernation method may further include writing a part of the hibernation image in the nonvolatile memory; detecting whether there is a new user input to cancel the hibernation operation while the part of the hibernation image is written in the nonvolatile memory; and determining whether the hibernation image is entirely written in the nonvolatile memory.

In an example embodiment, the hibernation operation may be cancelled and the priority working group may be activated in response to the new user input.

In an example embodiment, the hibernation method may further include allowing the computing apparatus to enter a power-saving mode.

According to another example embodiment, the computing apparatus may include a main memory; a user interface receiving a user input to cancel a hibernation operation; a control unit configured to classify some processes or some pages among working processes into a priority working group according to priority for restoring a working state and cancel the hibernation operation and activate the priority working group in response to the user input; and a nonvolatile memory in which a hibernation image including the priority working group is written.

In an example embodiment, the priority working group may include a rendering process among the working processes or a graphic user interface.

In an example embodiment, the priority working group may include background pages required to drive the rendering process or a process having the graphic user interface.

In an example embodiment, the background pages may include pages activated within a pre-set time, among the working processes, when the working processes are re-run after the main memory is shrunk.

In an example embodiment, the hibernation image may be divided into a plurality of pieces and the pieces may be sequentially written in the nonvolatile memory, and the control unit may detect whether there is a new user input to cancel the hibernation operation whenever the pieces are written in the nonvolatile memory and cancels the hibernation operation in response to the new user input.

In an example embodiment, the higher priority working processes include at least one of processes and pages of working processes.

According to at least one example embodiment of the inventive concepts, the hibernation method may include classifying higher priority working processes into a priority working process according to priority for restoring a working state of the computing apparatus; initiating a hibernation operation; detecting a user input to cancel a hibernation operation; cancelling the hibernation operation and activating the priority working group in response to the user input; and activating processes that are not classified into the priority working group after activating the priority working group.

In an example embodiment, the priority working group may include visualization processes among the working processes.

In an example embodiment, the visualization processes may include a rendering process or processes having a graphic user interface.

In an example embodiment, the hibernation method may further include generating a hibernation image including the priority working group; writing a part of the hibernation image in the nonvolatile memory; detecting whether there is a new user input to cancel the hibernation operation while the part of the hibernation image is written in the nonvolatile memory; and determining whether the hibernation image is entirely written in the nonvolatile memory.

### BRIEF DESCRIPTION OF THE DRAWINGS

Example embodiments will be more clearly understood from the following brief description taken in conjunction with the accompanying drawings. FIGS. 1-6 represent non-limiting, example embodiments as described herein.

FIG. 1 is a flowchart illustrating a typical hibernation method;

FIG. 2 is a flowchart illustrating a hibernation method according to an example embodiment of the inventive concepts;

FIG. 3 illustrates a step S200 in FIG. 2 in detail;

FIG. 4 illustrates a step S220 in FIG. 2 in detail;

FIG. 5 is a block diagram of a computing apparatus according to an example embodiment of the inventive concepts; and

FIG. 6 is an example diagram in which the inventive concepts are applied to a mobile device.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that in the specification, the terms “comprise” and/or “comprising” specify existence of shapes, numbers, steps, operations, members, elements, and/or groups thereof, which are referred to, and do not exclude existence or addition of one or more different shapes, numbers, operations, members, elements, and/or groups thereof. In addition, an embodiment described and exemplified herein includes a complementary embodiment thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

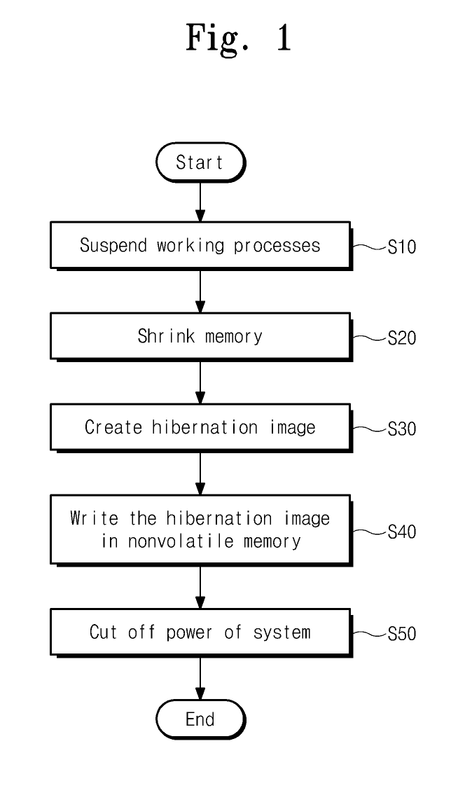

FIG. 1 is a flowchart illustrating a typical hibernation method. As illustrated, the hibernation method includes steps S10 to S50.

At step S10, working processes are suspended when a hibernation interrupt is detected. The hibernation interrupt may be generated when a computing apparatus is not used for a long period of time or by a user command.

At step S20, a main memory of the computing apparatus is shrunk. At step S30, a hibernation image for the working processes suspended at step S10 is created. The hibernation image may be a kind of storage format for writing a working state in a nonvolatile memory.

At step S40, the created hibernation image is written in a storage medium. Because a power supplied to the computing apparatus may be cut off in a hibernation state, a storage medium in which the hibernation image is to be written may be a nonvolatile memory.

At step S50, the computing apparatus enters a power-saving mode. In the power-saving mode, the power supplied to the computing apparatus may be partially or entirely cut off. The power-saving mode may also be referred to as hibernation mode.

The above-described configuration makes it possible to reduce a standby power that the computing apparatus consumes when a user does not use a computer. Unfortunately, the hibernation may suffer from several drawbacks.

One of the several drawbacks is that it takes a given amount of time when hibernation is cancelled halfway. For example, the hibernation may not be cancelled while a processor writes a hibernation image in a nonvolatile memory. The cancel of the hibernation may not be performed until the hibernation image is completely written in the nonvolatile memory. For example, it is not possible to immediately respond to a user request for cancelling the hibernation.

Another drawback is that it takes a length of time to restore a previous working state. Although hibernation-based booting is faster than complete re-execution of a computing system, considerable time is still required for the hibernation-based booting. For the purpose of the user convenience, it is preferable to reduce restoration time of the hibernation.

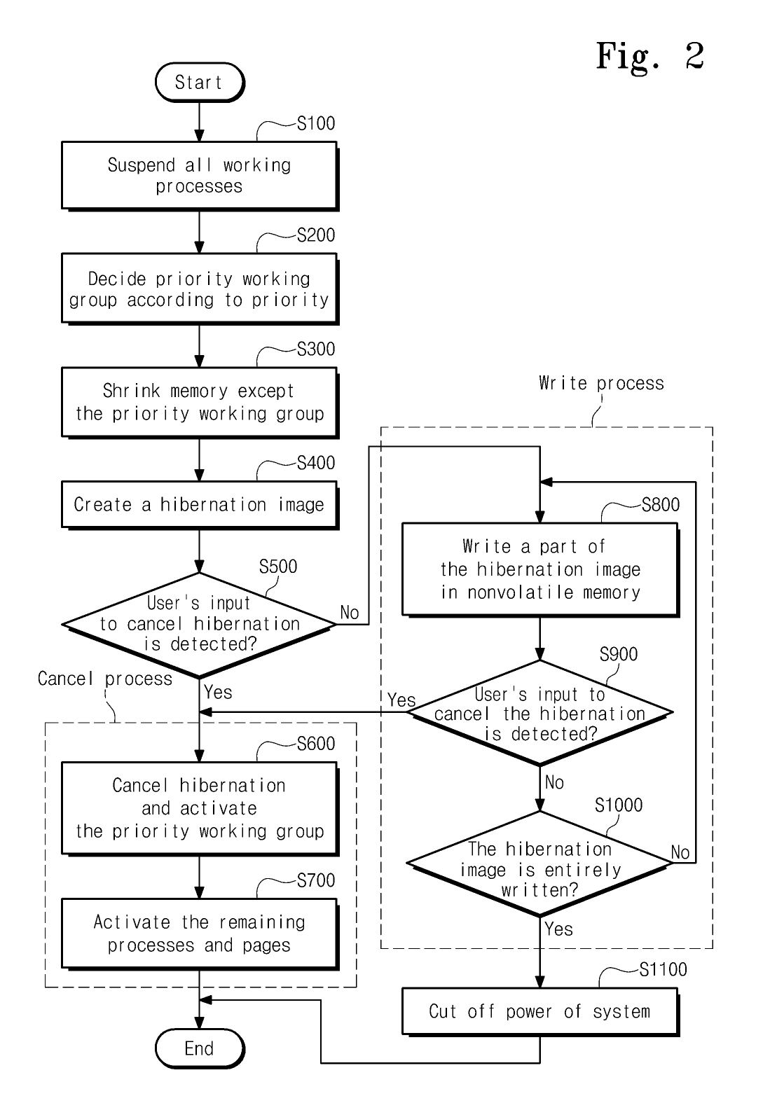

FIG. 2 is a flowchart illustrating a hibernation method according to an example embodiment of the inventive concepts. As illustrated, the hibernation method may include steps S100 to S1100.

At step S100, processes that are working (hereinafter referred to as “working processes”) are suspended when a hibernation interrupt is detected. The hibernation interrupt is generated when a given event condition is satisfied. The event condition may be a condition where there is a user hibernation command or there is no user input for a given time.

At step S200, a control unit of a computing apparatus categorizes some of the working processes suspended at step S100 or some pages into a priority working group. The priority working group is decided according to a priority for restoring a previous working state. The priority working group may include a plurality of processes or pages.

Although it will be described later, the priority working group is activated when the computing apparatus is restored from a power-saving mode or a hibernation operation is cancelled. For this reason, programs viewed by the user may be driven. Accordingly, the user may recognize that the working state is restored even if the entire process is not activated. This leads to a decrease in restoration time that the user feels and an increase in user convenience.

At step S300, a main memory allocated to the working processes is shrunk. In an example embodiment, a main memory allocated to the priority working group may not be shrunk. Thus, the priority working group may be activated promptly when the hibernation is cancelled.

At step S400, a hibernation image for the working processes is created. The hibernation image may include the priority working group. The hibernation image may be a kind of storage format for writing a previous working state in a storage medium.

At step S500, it is detected whether there is a user input to cancel the hibernation. When the user wants to reuse the computing apparatus, the user may cancel the hibernation that is in progress. Thus, the user need not wait for the end of the hibernation and re-execution of the computing apparatus.

The user input to cancel the hibernation may be variously defined. The user input is inputting a specific command, pressing any key on a keyboard or touching any point of a touch screen.

In the above example embodiment, the user input is detected following step S400. However, this is merely an example and the user input may be detected at any moment of the hibernation procedure.

In an example embodiment, when the user input is detected, information on the user input may be stored in a specific register. At any step of the hibernation, the computing apparatus may cancel the hibernation operation with reference to the register.

When the user input is detected, the flow proceeds to a cancel process (S600 to S700). Otherwise, the flow proceeds to a write process (S800 to S1000).

The cancel process may include steps S600 and S700.

At step S600, the control unit of the computing apparatus cancels the hibernation and activates the priority working group. The programs viewed by the user may be driven by activating the priority working group. Thus, the user may recognize that a working state is restored even if the entire process is not activated. This leads to a decrease in restoration time that the user feels and an increase in user convenience.

On the other hand, when the hibernation is canceled, the hibernation image may be erased for efficient use of a memory.

At step S700, remaining processes or pages of a working process other than for the priority working group are activated. When the remaining processes or pages are activated, the entire work process is activated and the previous working state is restored.

The write process may include steps S800 to S1000. In the write process, the previous working state is written in the storage medium.

At step S800, the hibernation image is written in a storage medium. Because the hibernation image must be stored even in the power-saving mode state, the storage medium may be a nonvolatile memory. In an example embodiment, the nonvolatile memory may be a magnetic storage medium or a NAND flash memory.

In an example embodiment, a part of the hibernation image may be written. A time interval to detect the user input may be reduced by dividing the hibernation image into a plurality of pieces and writing the pieces in a nonvolatile memory. Thus, the user' input to cancel the hibernation may be detected faster and the hibernation may be cancelled rapidly.

In contrast, if the entire hibernation image is written in a single unit, it is necessary to wait until the hibernation image is completely written. Accordingly, waiting time for cancelling the hibernation increases and impairs the user convenience.

Although the expression “dividing the hibernation image” is used herein, it does not necessarily mean “comprising a dividing step.” The word “dividing” may mean any method of storing a hibernation image after dividing the hibernation image through at least two steps.

At step S900, it is detected whether there is a new user input to cancel the hibernation while the part of the hibernation image is stored. If the new user input is detected, the flow proceeds to the cancel process (S600 to S700). If the new user input is not detected, the flow proceeds to step S1000.

In the above example embodiment, the new user input is detected in the course of writing the hibernation image. However, this is merely an example and the new user input may be detected at any moment of the hibernation procedure.

In an example embodiment, when a new user input is detected, information on the new user input may be stored in a specific register. At any step of the hibernation, the computing apparatus may cancel the hibernation operation with reference to the register.

In an example embodiment, if the flow proceeds to the cancel process, the hibernation image written in the nonvolatile memory may be erased.

If the flow proceeds to the cancel process, the subsequent process is identical to the above-described process (S600 and S700).

At step S1000, it is determined whether the hibernation image is entirely written in the nonvolatile memory. If the hibernation image is not entirely written, the flow proceeds to step S800 at which a loop of the write process (S800 to S1000) is repeated.

If the hibernation image is entirely written, the flow proceeds to step S1000. In an example embodiment, a main memory allocated to a priority working group and the hibernation image may be shrunk.

At step S1000, the computing apparatus enters a hibernation state (hereinafter referred to as “power-saving mode”). In the power-saving mode, a power supplied to the computing apparatus is partially or entirely cut off. In the power-saving mode, the power consumed in the computing apparatus is minimized or reduced. When the computing apparatus is then reactivated, a previous working state may be restored from the hibernation image stored in the nonvolatile memory.

In an example embodiment, the priority working group may be activated to shorten the restoration time that the user feels, as previously described at step S200.

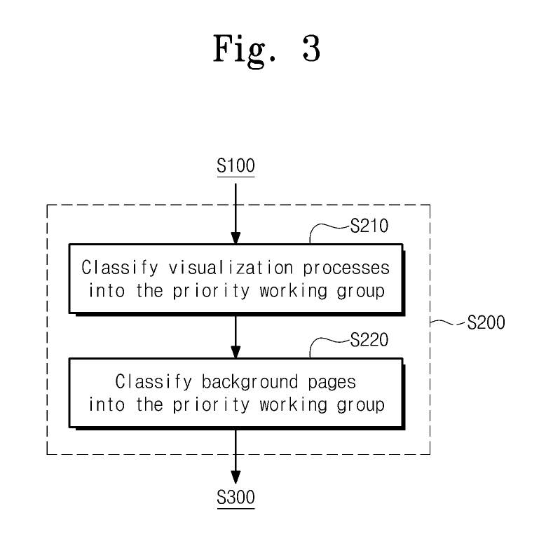

FIG. 3 illustrates step S200 in FIG. 2 in detail. As illustrated, step S200 may include steps S210 and S220.

In an example embodiment, the priority working group may have a higher priority than remaining processes or pages in a working process. When the hibernation is cancelled or the computing apparatus is activated, the priority working group may be activated according to the priority.

At step S210, among working processes, a process providing a visualization effect to a user (hereinafter referred to as “visualization process”) is classified into the priority working group. For example, visualization processes have higher priority. The visualization effect means an effect by which graphical elements displayed on a display screen are implemented. A rendering process or processes having a graphic user interface may be classified into the visualization process.

At step S220, among the working processes, a page required for driving the computing apparatus and the visualization process (hereinafter referred to as “background page”) is classified into the priority working group.

In an example embodiment, processes predesignated by a user, a software maker or a manufacturer of a computing apparatus (hereinafter referred to as “designated processes”) may be additionally classified into the priority working group.

Among the working processes, the other processes and pages that are not classified into the priority working group have a lower priority. For instance, a process having no visualization effect and performing only an internal operation may have a lower priority.

As set forth above, the priority is divided into the priority of the priority working group and the priority of the other groups. However, this is merely an example and working processes may be divided into two or more process groups. In an example embodiment, the priority may be given among a visualization process, a designated process, and background pages.

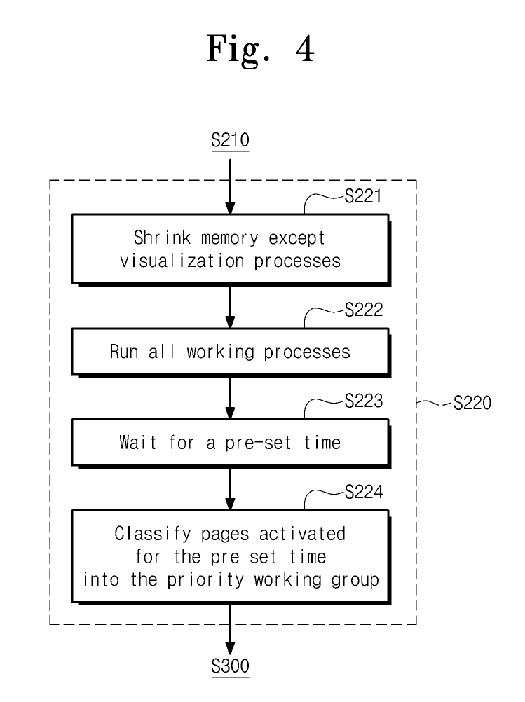

FIG. 4 illustrates step S220 in FIG. 2 in detail. A detailed example embodiment of a method for deciding the background page in FIG. 3 will now be described in FIG. 4. Referring to FIG. 4, step S220 may include steps S221 to S224.

At step S221, all main memories are allocated to the working process.

At step S222, the working processes are re-run.

At step S223, waiting is done for a pre-set time after re-running the working processes.

At step S224, among pages of the working process, pages activated within the pre-set time are classified into the priority working group. Pages activated within a given time (e.g. the pre-set time) may be regarded as pages essential to the operation of a system. This is because there is a high possibility that these pages are pages essential to fast booting (or restoration of a working state).

The pre-set time is a time given by a hardware maker, a software maker or a user. The longer the pre-set time, the larger the number of background pages. According to the above configuration, there may be provided an embodiment in which background pages are determined.

As set forth above, a hibernation method according to example embodiments have been described. According to the hibernation method, at the step of writing a hibernation image, a user input is checked at each short time interval. Thus, the hibernation may be cancelled promptly.

In addition, when a previous working state is restored, working processes having a higher priority (priority working processes) are first restored. Thus, restoration speed of the previous working state may be improved.

In addition, there is provided a detailed example embodiment of a method for classifying working processes according to priority.

In addition, because the hibernation may be cancelled promptly, the user convenience is not impaired in spite of frequent use of the hibernation. Thus, the hibernation may be frequently used and power loss of the computing apparatus may be further reduced.

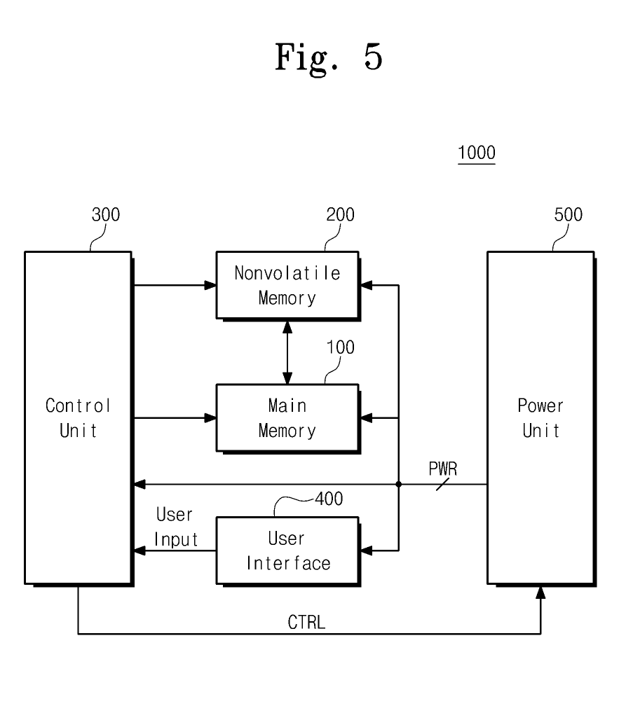

FIG. 5 is a block diagram of a computing apparatus 5000 according to an example embodiment of the inventive concepts. As illustrated, the computing apparatus 5000 may include a main memory 100, a nonvolatile memory 200, a control unit 300, a user interface 400, and a power unit 500. The computing apparatus 5000 supports a hibernation function.

The main memory 100 provides a memory required for the operation of working processes. The main memory 100 may include a dynamic random access memory (DRAM) or a static random access memory (SRAM).

The user interface 400 receives a user input to cancel a hibernation operation. The user interface 400 may include various types of user input devices (not shown). The user input device may be a keyboard, a mouse, a microphone or a touch screen. Additionally, the user input device may be various types of signal receiving devices. The received user input is provided to the control unit 300.

The control unit 300 controls a series of steps at which the computing apparatus 1000 stores a current working state and enters a power-saving mode (hereinafter, the series of steps will be referred to as “hibernation operation”). Also the control unit 300 cancels the hibernation according to the user input received from the user interface 400.

More specifically, in the hibernation operation, the control unit 300 detects a hibernation interrupt. The hibernation interrupt is generated by a specific event such as, for example, when a user inputs a hibernation command or the computing apparatus 1000 is not used for a long period of time.

The control unit 300 stops a process that is working (hereinafter referred to as “working process”) in the main memory 100 according to the hibernation interrupt. The control unit 300 classifies some of the stopped working processes or some pages as a priority working group according to priority. The classifying method is the same as described above.

The control unit 300 generates a hibernation image including the priority working group. The generated hibernation image is written in the nonvolatile memory 200.

When writing of the hibernation image is completed, the control unit 300 allows the computer apparatus 1000 to enter a power-saving mode. In the power-saving mode, the control unit 300 controls the power unit 500 to partially or entirely cut off a driving power PWR supplied to the computing apparatus 1000.

In the cancellation of the hibernation, the control unit 300 detects a user input to cancel the hibernation. The user input may be generated during the hibernation operation.

When the user input is detected during the hibernation operation, the control unit 300 cancels the hibernation operation and activates the working processes. At each step of the hibernation process, it is checked whether the user input is detected.

In an example embodiment, when the hibernation image is written, it may be divided into a plurality of pieces and the pieces may be sequentially written in the nonvolatile memory 200. Each time the pieces are written, the control unit 300 checks whether the user input is detected. As a result, the user input may be detected in a shorter period of time and the hibernation may be cancelled promptly.

The control unit 300 differentially activates respective process groups according to the priority for restoring a previous working state. Processes having a higher priority (e.g., priority working group) are first activated to improve the restoration speed that the user feels. The control unit 300 may erase the hibernation image stored in the main memory 100 or the nonvolatile memory 200 to reduce unnecessary memory consumption.

Also, the control unit 300 differentially activates the respective process groups according to the priority when the previous working state is restored from a power-saving mode state. A detailed activating method is the same as described above.

The nonvolatile memory 200 stores the hibernation image. The hibernation image stored in the nonvolatile memory 200 is not erased in the power-saving mode. In an example embodiment, the nonvolatile memory 200 may be a magnetic field recording medium, a hard disk drive (HDD) or a NAND flash memory.

The power unit 500 supplies a driving power PWR required for the computing apparatus 100. The driving power PWR supplied by the power unit 500 may be controlled by the control unit 300. The control of the driving power PWR may be done through a power control signal CTRL. In the power-saving mode, the power unit 500 may partially or entirely cut off the driving power PWR.

According to the above configuration, the computing apparatus 1000 may enter the power-saving mode through the hibernation operation. Thus, the power consumption of the computing apparatus 1000 may be reduced. In addition, the hibernation may be cancelled promptly. In addition, restoration speed of the previous working state may be improved.

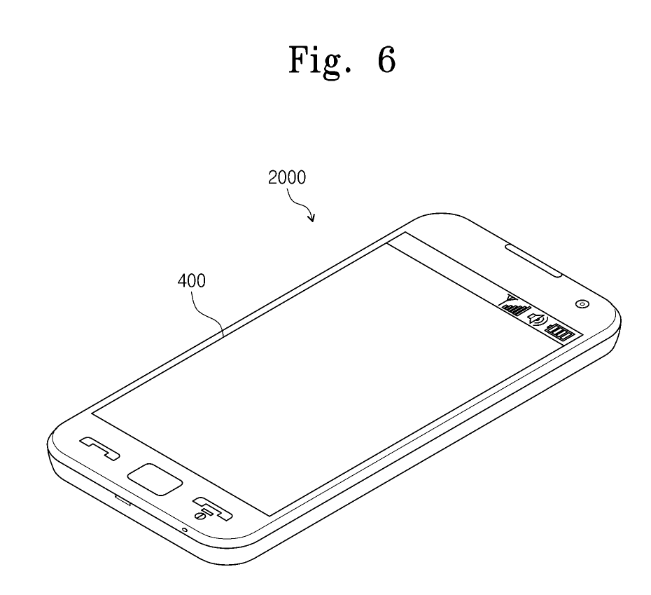

FIG. 6 is an example diagram in which the inventive concepts are applied to a mobile device 2000. As illustrated, the mobile device 2000 may include a user interface 400.

Although not shown in the figure, the mobile device 2000 may further include a main memory, a nonvolatile memory, a control unit, and a power unit. The functions and configurations of the main memory, the nonvolatile memory, the control unit, and the power unit are the same as described in FIG. 5.

The power unit may include a portable battery (not shown). The portable battery may be a lithium-ion battery.

The user interface 400 may be a touch screen. When the mobile device 2000 performs a hibernation operation or is in a power-saving mode, a user input may be received from the user interface 400. In an example embodiment, the user input may be touching any point of the touch screen.

A method of cancelling hibernation and a method of restoring a previous working state by a user input are the same as described above.

A computing apparatus and a hibernation method according to an example embodiment of the inventive concepts are applied to the mobile device 2000, reducing the power consumption of the mobile device 2000 and rapidly performing the cancellation of hibernation and the restoration of a previous working state. Thus, user convenience is enhanced and the performance of the mobile device 2000 is improved.

According to a computing apparatus and a hibernation method described so far, hibernation that is in progress may be rapidly cancelled in response to a user input. In addition, a previous working state may be rapidly restored from a hibernation state. Power consumption may be reduced.

While example embodiments have been particularly shown and described, it will be understood by one of ordinary skill in the art that various changes in form and detail may be made therein without departing from the spirit and scope of the claims.

What is claimed is:

1. A hibernation method of a computing apparatus, comprising:
classifying at least one of some processes and some pages of working processes into a priority working group according to priority for restoring a working state of the computing apparatus;
detecting a user input to cancel a hibernation operation;
cancelling the hibernation operation and activating the priority working group in response to the user input; and
activating at least one of processes and pages that are not classified into the priority working group after activating the priority working group.

2. The hibernation method as set forth in claim 1, wherein the priority working group includes visualization processes among the working processes.

3. The hibernation method as set forth in claim 2, wherein the visualization processes includes at least one of a rendering process and a process having a graphic user interface (GUI).

4. The hibernation method as set forth in claim 3, wherein the priority working group includes background pages required to drive the computing apparatus and the visualization processes.

5. The hibernation method as set forth in claim 4, wherein the background pages include pages activated within a pre-set time, among the working processes, when the working processes are executed after a main memory of the computing apparatus is initialized.

6. The hibernation method as set forth in claim 4, wherein the priority working group includes processes given by at least one of a manufacturer and a user of the computing apparatus.

7. The hibernation method as set forth in claim 1, further comprising:
generating a hibernation image including the priority working group.

8. The hibernation method as set forth in claim 7, further comprising:
writing a part of the hibernation image in the nonvolatile memory;
detecting whether there is a new user input to cancel the hibernation operation while the part of the hibernation image is written in the nonvolatile memory; and
determining whether the hibernation image is entirely written in the nonvolatile memory.

9. The hibernation method as set forth in claim 8, wherein the hibernation operation is cancelled and the priority working group is activated in response to the new user input.

10. The hibernation method as set forth in claim 8, further comprising:
allowing the computing apparatus to enter a power-saving mode.

11. A computing apparatus comprising:
a main memory;
a user interface receiving a user input to cancel a hibernation operation;
a control unit configured to classify higher priority working processes into a priority working group according to priority for restoring a working state and cancel the hibernation operation and activate the priority working group in response to the user input; and
a nonvolatile memory configured to record a hibernation image including the priority working group.

12. The computing apparatus of claim 11, wherein the priority working group includes at least one of a rendering process among the working processes and a graphic user interface (GUI).

13. The computing apparatus of claim 12, wherein the priority working group includes at least one of background pages required to drive the rendering process and a process having the graphic user interface.

14. The computing apparatus of claim 13, wherein the background pages include pages activated within a pre-set time, among the working processes, when the working processes are re-run after the main memory is shrunk.

15. The computing apparatus of claim 11, wherein the control unit is configured to divide the hibernation image into a plurality of pieces and the nonvolatile memory is configured to sequentially record the pieces in the nonvolatile memory, and
wherein the control unit is configured to detect whether there is a new user input to cancel the hibernation operation whenever the pieces are written in the nonvolatile memory and cancel the hibernation operation in response to the new user input.

16. The computing apparatus of claim 11, wherein the higher priority working processes include at least one of processes and pages of working processes.

17. A hibernation method of a computing apparatus, comprising:
classifying higher priority working processes into a priority working group according to priority for restoring a working state of the computing apparatus;
initiating a hibernation operation;
detecting a user input to cancel the hibernation operation;
cancelling the hibernation operation and activating the priority working group in response to the user input; and
activating processes that are not classified into the priority working group after activating the priority working group.

18. The hibernation method as set forth in claim 17, wherein the priority working group includes visualization processes among the working processes.

19. The hibernation method as set forth in claim 18, wherein the visualization processes includes at least one of a rendering process and a process having a graphic user interface (GUI).

20. The hibernation method as set forth in claim 17, further comprising:
generating a hibernation image including the priority working group;
writing a part of the hibernation image in the nonvolatile memory;
detecting whether there is a new user input to cancel the hibernation operation while the part of the hibernation image is written in the nonvolatile memory; and
determining whether the hibernation image is entirely written in the nonvolatile memory.
